(19) United States
(12) Patent Application Publication
(10) Pub. No.: US 2014/0081940 A1
(43) Pub. Date: Mar. 20, 2014

(54) System and Method for Data Transfer with a Battery Charger

(71) Applicant: DELTA-Q TECHNOLOGIES CORP., BURNABY (CA)

(72) Inventors: Jeff Douglas EVERETT, Vancouver (CA); Lloyd Edward GOMM, Surrey (CA); Russell Leslie LEWIS, North Vancouver (CA); Iqbal Tony MANHAS, Burnaby (CA); Christopher Ryan SINGER, Vancouver (CA); Fariborz MUSAVI, Coquitlam (CA); Ewan Murray EDINGTON, North Vancouver (CA)

(73) Assignee: DELTA-Q TECHNOLOGIES CORP., BURNABY (CA)

(21) Appl. No.: 14/032,032

(22) Filed: Sep. 19, 2013

Related U.S. Application Data
(60) Provisional application No. 61/703,652, filed on Sep. 20, 2012.

(51) Int. Cl. G06F 17/30

(52) U.S. Cl. CPC G06F 17/30091
USPC 707/705

(57) ABSTRACT

A system and method for transferring data between a charging system comprising a data control module and a removable memory is provided. The method comprises the data control module detecting a connection with a removable memory module and identifying and selecting a file on the removable memory. The data control module then obtains the selected file from the removable memory.

### CROSS-REFERENCE TO RELATED APPLICATIONS

This application claims priority to U.S. Provisional Patent Application No. 61/703,652, titled “SYSTEM AND METHOD FOR DATA TRANSFER WITH A BATTERY CHARGER”, and filed on Sep. 20, 2012, the entire contents of which are herein incorporated by reference.

### FIELD OF THE INVENTION

The present invention relates to a system and method for data transfer with a battery charger.

### BACKGROUND

A battery charger is a device used to restore energy to a rechargeable battery. A typical batter charger comprises a microprocessor to control the charging process, a memory, and a voltage regulator.

The optimum operational mode of a battery charger depends on several factors including cell chemistry, the design of each cell, the current that the battery can safely accommodate, the degree to which the battery is charged, and the temperature of the battery being charged.

Some battery chargers include a charge controller that can select the operational mode of the battery charger based on information input by a user or information obtained from a memory on the battery. This information includes the battery type, cell chemistry, and the battery's state of charge. For example, a memory on the battery may store data relating to the cell chemistry, the battery's date of manufacture and the battery model number. The battery charger can obtain this data through a connection with the battery or via a user interface. Some chargers can also obtain operational information from sensors in or around the battery as well as historical charging data from previous charging cycles.

### SUMMARY

According to an example embodiment of the present invention, there is provided a charging system having a data control module to initiate and control data transfer to and from a passive removable memory module. The data control module is also operable to initiate and administer updates and configuration changes to the charging system.

The data transfer is initiated and controlled by the data control module in the charging system and, aside from connecting the removable memory module to the charging system, does not require action from the user. The ability to transfer data to, and from, a charging system including software, firmware, additional or charging algorithms, configuration data, and battery charge history without requiring input from a user may reduce the time and expertise required from a user to perform an update. Furthermore, a user may, using several passive memory modules, transfer data to and from several charging systems simultaneously.

Passive memory modules are less physically cumbersome and expensive, have no moving parts, are relatively inexpensive, and do not require an external power source. Passive memory modules may also be constructed to be more durable and less prone to failure. For each of these reasons, passive memory modules are well-suited to field applications.

In an example embodiment, a charging system for a golf cart powered by a battery can select a charging algorithm that is optimized for a given battery; there may be a different algorithm for a sealed battery compared to an algorithm for a flooded battery.

In another example embodiment, a maintenance person may transfer data (e.g. not limited to charging algorithms) to and from a charging system on a golf cart using a passive memory module in the form of a USB thumb drive, which can be relatively small, inexpensive, damage resistant, and operable without a power source.

In one example aspect, a data control module, in a charging system, operable to transfer data to and from a removable memory is provided. The data control module is operable to obtain software and/or firmware updates from the removable memory and install such software and firmware updates in a charge controller. The charging system is further operable to obtain charge algorithm files, configuration files, and command files from a removable memory. The data control module is operable to store charge algorithm files in a charge algorithm database. The data control module is operable to apply configuration files to the charge controller. The data control module is also operable to execute commands obtained from the removable memory.

In another example aspect, a charging system comprising a data control module operable to generate a charge data package from a charge history database and provide the charge data package to a removable memory module is provided.

In yet another example aspect, a method of obtaining a data package from a removable memory is provided. The method comprises a data control module in a charging system obtaining a data package from a removable memory, the data package comprising one or more of a firmware update, a software update, a configuration file, a command file comprising computer executable instructions, or a charge algorithm. The data control module is operable to initiate and control the firmware and/or software update and to store the charge algorithm in the charge algorithm database.

In yet another example aspect, a method of a data control module in a charging system providing a charge data package to a removable memory is provided. The data control module is operable to generate one or more charge history files from the charge history database. The data control module is operable to generate a charge data package and provide the charge data package to the removable memory. The charge data package may later be obtained from the removable memory using a computing device.

### BRIEF DESCRIPTION OF THE DRAWINGS

Embodiments of the invention will now be described by way of example only with reference to the accompanying drawings in which:

FIG. 1 is a block diagram of a charging system comprising a data control module in communication with a removable memory;

FIG. 2 is a flow diagram of processor or computer executable instructions for a data control module to obtain data from a removable memory;

FIG. 3 is a flow diagram of processor or computer executable instructions for a data control module to provide data to a removable memory;

FIG. 4 is a block diagram of a charging system similar to that of FIG. 1 wherein the removable memory is in wireless communication with the data control module;

FIG. 5 is a block diagram of a charging system similar to that of FIG. 1 further comprising charge control sensors; and

FIG. 6 is another block diagram of a charging system similar to that of FIG. 1 further comprising other modules in communication with the data control module.

### DETAILED DESCRIPTION

To accommodate several types of batteries, the memory of the battery charging system may be provided with several charging algorithms. Each algorithm can be optimized for a particular type of battery, environment, or other factor. For example, a battery charging system may have a memory with instructions stored thereon to charge a first type of battery, for example, a lithium ion battery, according to a first charging algorithm but charge a second type of battery, for example, a lead-acid battery, according to another charging algorithm.

Each charging algorithm may be optimized for a particular battery type. By way of example, a charging system for a golf cart powered by a sealed battery can select a charging algorithm that is optimized for a sealed battery. Conversely, if the battery is a flooded battery, a charging algorithm optimized for a flooded battery would be selected.

Battery charging systems can be provided with software or firmware to control charging of the battery and record inputs from various sensors and user inputs. For example, battery charging system software can enable the charging system to charge the battery at user-specified time periods. To increase the versatility of a battery charging system, it is advantageous to have the capability to update any controlling software or firmware on the battery charging system to modify existing functionalities and/or to enable new functionalities. For example, the software of a battery charging system can be modified to provide the user with a warning when the battery's state of charge falls below a selected threshold.

Currently, software, firmware and charging algorithms on battery chargers are updated by bringing the battery charger into communication with an active computing device, for example, a laptop computer. The active computing device is used to initiate, control, and administer the update. A serial connection can be made between the charger and the computing device. The computing device typically updates the battery charger according to settings provided by the user.

The user can also use the computing device to extract information from the battery charger. For example, the user can obtain information relating to the state of charge of the battery, the type of battery, the number of charge cycles that the battery underwent, data relating to previous charge cycles, and the temperature of the battery.

A user must manually enter commands or control a software application on the active computing device to update the battery charger and/or extract information from the battery charger. This requires that a user have access to an active computing device, have knowledge of how to enter manual commands or control a software application on the field, and may require significant time from the user. Moreover, active computing devices are relatively expensive, physically cumbersome, require a power source, and are typically not built to withstand harsh treatment or the elements.

Data transfer to and from a battery charger has, in the past, required that an active computing device be placed in communication with the charger and operated by a user. As outlined above, battery chargers that require an active computing device to perform updates and to obtain data are fraught with disadvantages. A battery charging system operable to communicate with a passive memory module overcomes many of these disadvantages.

To permit the use of passive devices, the battery charging system described herein comprises a data control module. The data control module is an active module that obtains data from, and provides data to, the passive removable memory module. The data control module obviates the need for an active computing device to communicate with the charging system, as is further described herein.

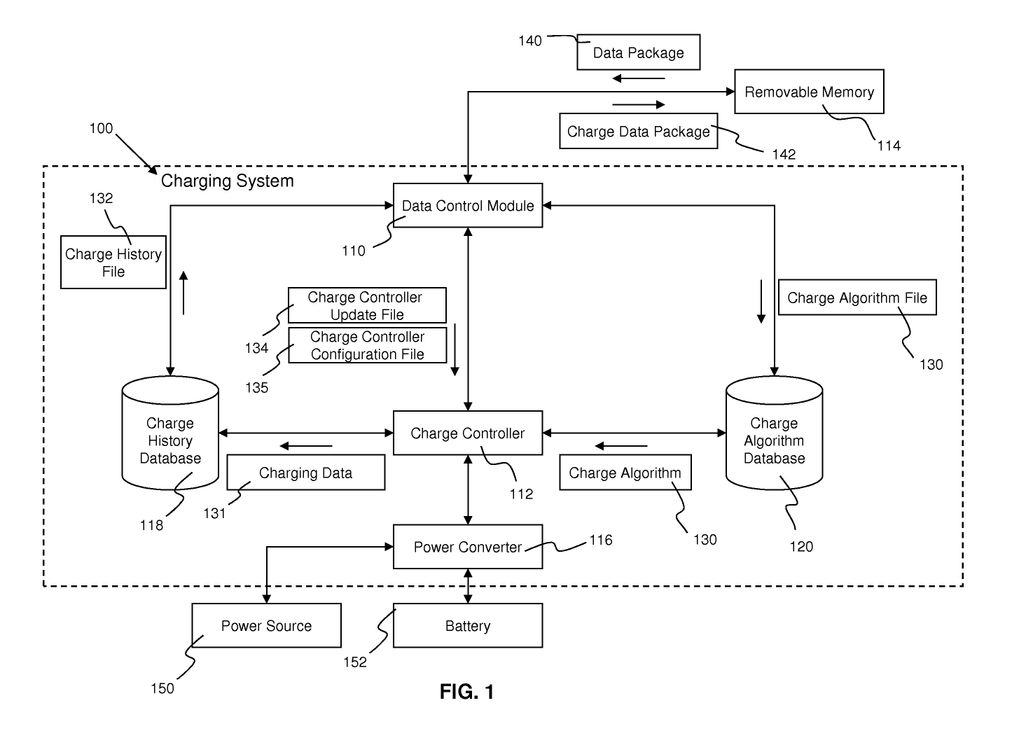

Turning now to FIG. 1, a charging system 100 operable to exchange data with a removable memory 114 is shown. The system comprises a charge controller 112 in communication with a power converter 116 and a data control module 110. The data control module 110 can be connected to a removable memory module 114.

The charging system also comprises a charge algorithm database 120 for storing charge algorithms and a charge history database 118 for storing charge data. Each of these databases is in communication with the charge controller 112 and the data control module 110.

The power converter 116 can be removably connected to a power source 150, for example, a 120V or 240V AC power source. The power converter 116 obtains power from the power source 150 and charges a battery 152 according to charging instructions provided by the charge controller 112. It will be appreciated that a circuit breaker or fuse can be provided between the power converter 116 and the power source 150 or the power converter 116 and the battery 152 to prevent damage that may be caused by a sudden power surge or a short in the system. It will be appreciated that the charging system may be operable to receive and charge two or more batteries 152 simultaneously.

As mentioned above, the power converter 116 charges the battery 152 based on charging instructions provided by the charge controller 112. The charge controller 112 is operable to generate instructions for the power converter 116 based on a charge algorithm obtained from the charge algorithm database 120. The charge controller 112 comprises firmware or software enabling the charge controller 112 to select an appropriate charge algorithm 130, as is further described below.

The charge controller 112 is operable to receive feedback from the battery 152 via the power converter 116 and/or other sensors, as will be described in detail below. The charging instructions provided to the power converter 116 are optimized by the charge controller 112 based on charging data 131, for example, the type of battery 152 being charged, the temperature of the battery 152, the temperature of the power converter 116, the state of charge of the battery 152, the serial number of the battery, any errors, warnings, alarms, or faults associated with the charging, any diagnostic feedback, or other relevant parameters.

In an example embodiment, the charge controller 112 provides charging instructions to the power converter 116 based on a selected charge algorithm 130. The charge algorithm database 120 stores a plurality of charge algorithms 130, each of which may be selected based on the charging data 131. For example, a first charge algorithm 130 may apply to lithium ion batteries. A second charge algorithm 130 may apply to lead acid batteries. As such, the charge controller 112 is operable to select a new charge algorithm 130 from the charge algorithm database 120 depending on a battery attribute, power converter attribute, environmental attribute, or other attribute during the charging process.

The charge controller 112 is operable to store charging data 131 in the charge history database 118. For example, the charge controller 112 may store a temperature profile of a battery 152 throughout a charging cycle, the state of charge of the battery 152 throughout, or at the completion of a charging cycle, the time required to charge the battery 152, a serial number of the battery 152, a reason for charge termination, the charging algorithm that was used, any error conditions encountered when charging the battery 152, the number of charge cycles that the power converter 116 and/or the battery 152 have undergone, etc. The charging data may correspond to data obtained at the beginning of a charging cycle, at the end of the charging cycle, throughout the charging cycle, or at select periods throughout the charging cycle. If the power converter 116 is connected to more than one battery 152 or removably connected to various batteries 152, each battery may be provided with identifying information which is obtained by the charge controller 112 via the power converter 116 and stored in the charge history database 118 to track battery-specific charge history.

The data control module 110 is operable to establish a connection and communicate with the removable memory module 114. The data control module 110 can obtain a data package 140 comprising software, firmware, a configuration file, additional or charging algorithms and provide the removable memory 114 with a charge data package 142. The data control module 110 is operable to search the passive memory module 114 for update files, select a relevant update file, and initiate an update of the charge controller 112. The data control module 110 is also operable to read instructions or configuration files from the removable memory 114 and execute or implement the instructions or configuration files, as will be further described herein.

It will be appreciated that the removable memory 114 is in communication with the data control module 110 via a wired connection or a wireless connection. In one example, the data control module 110 comprises a universal serial bus (USB) port operable to receive a removable memory module 114 comprising a USB thumb drive.

The data control module 110 is operable to process a data package 140 obtained from the removable memory 114. The data control module 110 is operable to provide charge algorithm files 130 to the charge algorithm database 120 and to provide charge controller update files 134 and charge controller configuration files 135 to the charge controller 112. A charge algorithm file 130 comprises one or more charging algorithms. The data control module 110 is also operable to obtain a charge history file 132 from the charge history database 118 and provide the charge history file 132 to the removable memory 114 in a charge data package 142.

The charging system 100 may be enclosed within a housing (not shown). The housing may, for example, be weatherproof to prevent ingress of water and dust, which can affect the operation of the charging system. Ports provided in the weatherproof housing may be protected by weatherproof plugs when not in use.

By way of example, the data control module 110 may be provided with a universal serial bus (USB) port operable to receive a USB adapter or a USB thumb drive comprising a flash memory. In the example of the USB thumb drive, files may have previously been stored on the USB thumb drive by a computing device. The removable memory 114, when in communication with the data control module 110, is a passive component and, as such, does not require an external power source. However, it will be appreciated that the removable memory 114 may comprise the memory of a portable computing device, for example, a smartphone, that is being used as a portable USB drive and not as an active computing device.

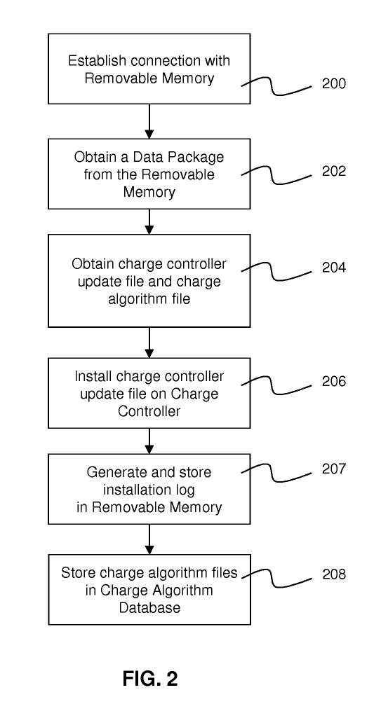

The data control module 110 is operable to obtain a data package 140 from the removable memory 114. Referring now to the example process outlined in FIG. 2, in 200, the data control module 110 establishes a connection with the removable memory 114. In 202, the data control module 110 selects and obtains a data package 140 stored on the removable memory 114. The data control module 110 then processes the data package 140 to extract one or more of a charge controller update file 134, a configuration file 135, a command file comprising computer executable instructions, or a charge algorithm file 130 in 204.

The charge controller update file 134 comprises one or more of a firmware update or a software update. The data control module 110 is operable to install a charge controller update file 134 on the charge controller 112 in 206. In 207, the data control module 110 generates an installation log recording information regarding the installation of the charge controller update file and stores the installation log on the removable memory 114. The installation log may comprise an installation success or failure indication, one or more error codes, or other information relevant to the installation process. In 208, the data control module 110 stores a charge algorithm file 130 in the charge algorithm database 120. The data control module 110 is operable to initiate and control the installation of software and/or firmware updates. It will be appreciated that although examples are given with reference to firmware updates and software updates, the principles discussed herein are also applicable to transfer other types of files into relevant modules or databases databases, for example, command files, configuration files, charge algorithm files.

The data control module 110 is also operable to apply a charge controller configuration file 135 obtained from the data package 140 to the charge controller 112. The charge controller configuration file 135 comprises configuration changes which are to be applied to the charge controller 112. Configuration options may comprise, for example, the amount of power that the power converter 116 may obtain from the power source 150, the time at which the power converter 116 charges the battery 152, a threshold at which the power converter 116 is to initiate charging, or a threshold at which the power converter 116 is to cease charging. The configuration file 135 may comprise a set of instructions to change one or more configuration settings, for example, instructions to change an initiate charging threshold and instructions to change a cease charging threshold. The configuration file 135 may otherwise comprise a replacement set of all or some of the configuration settings that override existing configuration settings.

The data control module 110, upon establishing a connection with the removable memory 114, is operable to perform a scan of the removable memory to identify and select any data packages 140. For example, each data package 140 may be identified by a reference code comprising, or linked to, a file version number, a charge controller model number or other metadata. The data control module 110 is operable to select a data package 140 based on the reference code of the data package 140. Upon selecting a data package, 140, the data control module 110 obtains the data package 140 from the removable memory.

The data control module 110 is also operable to provide any charge algorithm files 130 extracted from the data package 140 to the charge algorithm database 120.

The data package 140 may be installed on the removable memory manually using a computing device or using a specific data package installation application on the computing device. If, upon connecting the removable memory 114 to the data control module 110, the data control module 110 does not detect a relevant data package 140, the data control module 110 is operable to output an error condition to the user, for example, via a display or a speaker on the charging system 100 or on a module in communication with the data control module 110.

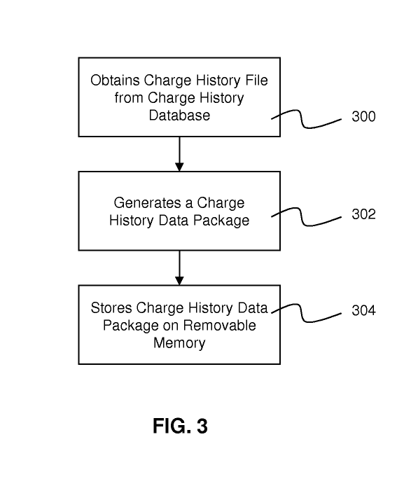

Turning to FIG. 3, the data control module 110 is operable to generate a charge history file 132 based on data obtained from the charge history database 118. This data may comprise, for example, battery capacity, battery state of charge, a cumulative charge cycle count for a particular battery, one or more battery serial numbers, a log of error codes, the charge controller model number, the power converter model number, a current software version on the charge controller 112, etc. In 300, the data control module 110 obtains one or more charge history files 132 from the charge history database 118 and in 302, generates a charge data package 142 from the charge history files 132. The data control module 110 stores the charge data package 142 on the removable memory 114.

The charge data package 142 may later be obtained from the removable memory 114 using a computing device and the charge history data may be analyzed to determine whether the battery and/or the power converter 116 needs reconditioning or replacement. The charge history data may also, or in addition, be used to optimize future charging algorithms and record data associated with the power converter 116 and/or battery 152.

It will be appreciated that the data control module 110 is also operable to generate, obtain, or both, from other modules installation logs comprising, for example, installation error codes and an installation confirmation. Similarly, the data control module 110 may store a log detailing the command files that were executed and the configuration files that were applied to the charge controller 112. These logs may be provided, by the data control module 110, to the removable memory module 114.

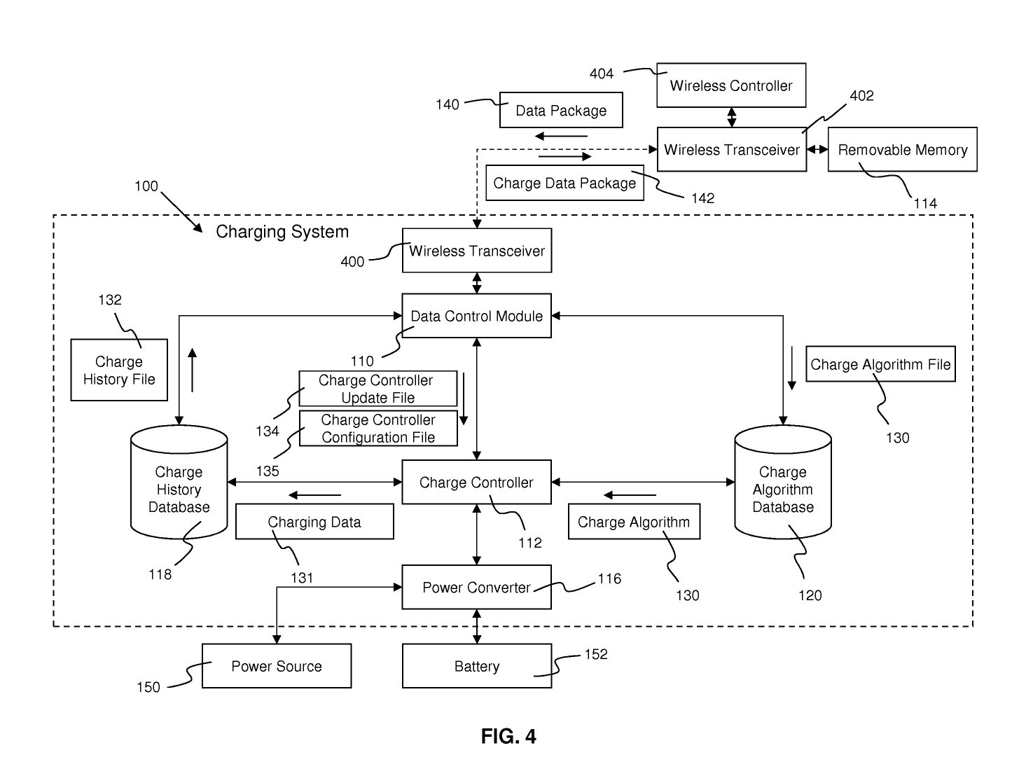

Referring now to FIG. 4, a charging system 100 similar to that of FIG. 1 is provided. The charging system 100 further comprises a first wireless transceiver 400 and a second wireless transceiver 402. The second wireless transceiver 402 is removably connected to a memory 114. The second wireless transceiver 402 is in communication with a wireless controller 404, which is operable to initiate and direct communication of the second wireless transceiver 402. The wireless controller 404 may comprise, or be connected to, a power source.

The first wireless transceiver 400 is operable to communicate with a second wireless transceiver 402. For example, if the charging system 100 is installed in a golf cart and is not readily accessible to a user, the second wireless transceiver 402 and the wireless controller 404 can be installed in a location that is more easily accessible to a user, for example, a dashboard of the golf cart. In an example embodiment, the wireless transceiver 402 and the wireless controller 404 are modules of a mobile electronic device, for example, a smartphone.

If the charging system 100 of FIG. 4 comprises a housing, for example, a weatherproof housing, the first wireless transceiver 400 may be located within the housing whereas the second wireless transceiver 402 may be located outside of the housing. By providing a first wireless transceiver 400 within the housing and a second wireless transceiver 402 outside of the housing, data communication between the removable memory 114 and the data control module 110 is enabled without having a physical connection penetrating the housing.

The wireless transceivers 400, 402 may be Bluetooth transceivers, Wi-Fi transceivers, infrared transceivers, or cellular transceivers. It will be appreciated by a person familiar with wireless communication technology that various other types of transceivers may be used.

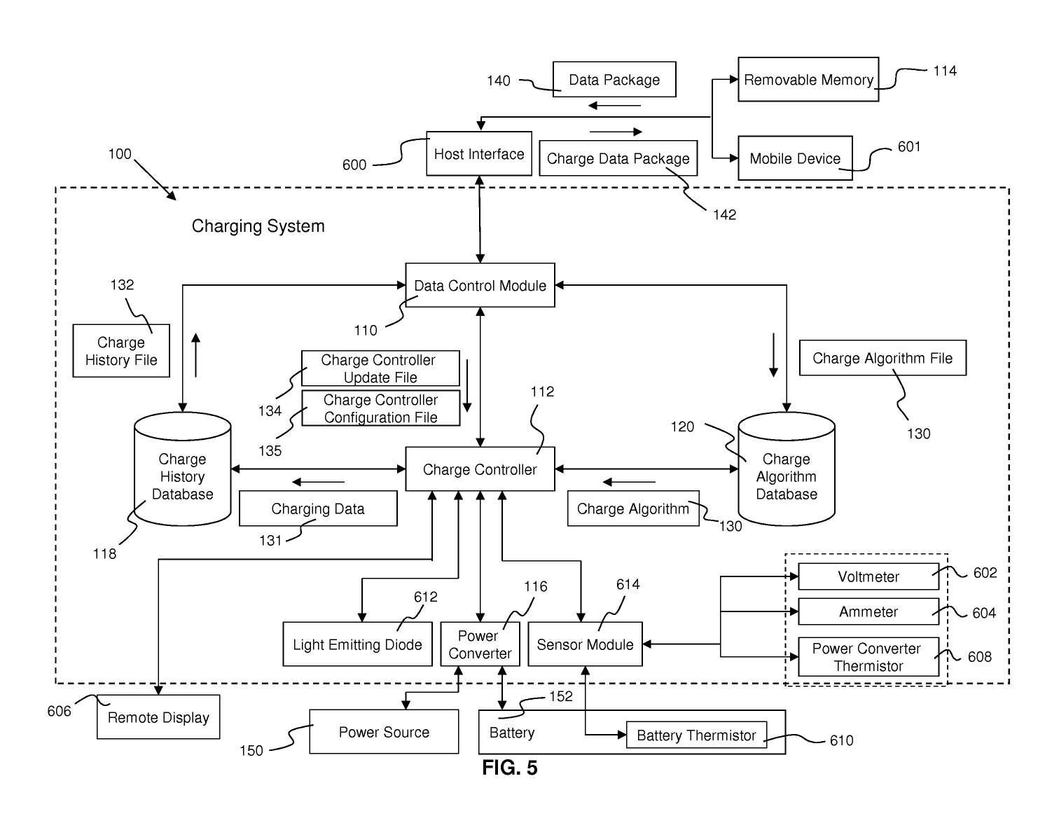

Alternatively, or in addition, the data control module 110 may be provided with a removable memory interface located on the exterior of the housing and/or outside of the housing. In the example of FIG. 5, the charging system 100 comprises a host interface 600. The host interface 600 may be, for example, a USB host interface or a secure digital host interface. The host interface 600 is operable to receive the removable memory module 114, for example, a USB thumb drive and/or a secure digital (SD) removable memory module 114. In the example of FIG. 5, the host interface 600 is also operable to connect to a mobile device 601 via USB cable and charge the mobile device. For example, if the charging system 100 is installed on a golf cart, a USB host interface can be provided in an area of the golf cart that is conveniently accessed by a driver or passenger. The driver or passenger can charge a mobile device 601, for example, a smartphone or digital camera, though the host interface 600. Similarly, the host interface 600 provides a maintenance person a convenient interface in which to insert a USB thumb drive or other removable memory module 114.

It will be appreciated that although the preceding example is provided in the context of a USB host interface and/or a SD host interface, other interfaces can be used, for example other serial interfaces or fibre-optic interfaces.

Referring back to FIG. 5, the charging system 100 further comprises a sensor module 614 in communication with the charge controller 112. The sensor module 614 is operable to obtain sensor data from one or more sensors located in the charging system 100 and/or in or around the battery 152. The sensor module 614 is in communication with one or more of a voltmeter 602, an ammeter 604, and a power converter thermistor 608, each of which are located within the charging system 100. It will be appreciated that the sensor module 614 may be connected to one or more other sensors, which may be located inside or outside of the charging system 100. A battery thermistor 610 or other temperature sensor is located in or on the battery 152. For example, a battery thermistor 610 may be located on the negative terminal of the battery 152. The battery thermistor 610 or other temperature sensor may also be in a location adjacent to the battery 152 such that the sensor may record the battery temperature or a temperature corresponding to a temperature of the battery. The sensor module 614 obtains sensor data from the sensors 602, 604, 608, and 610, as well as any other sensors, and provides the sensor data to the charge controller 112. As outlined above, the charge controller is operable to select the charge algorithm 130 from the charging algorithm database 120 based on the sensor data. The charge controller may also be operable to optimize one or more charge algorithms based on sensor data and battery data, and data from other modules that may be in communication with the charging system 100. For example, the charge controller 112 may select a charging algorithm based on the temperature of the battery, as measured by a thermistor located in the battery.

The charge controller 112 of FIG. 5 is also provided with a display, for example, a 7 segment display and/or a series of light emitting diodes 612 which indicate to the user the status of the power converter, the state of charge of the battery, the occurrence of any errors, etc. It will be appreciated that other, more sophisticated displays may also be used including a liquid crystal display (LCD), an E-ink display, or an organic light emitting diode display (OLED).

In some embodiments, the charge controller 112 is provided with a remote display 606. The remote display may be, for example, an LCD display, and E-ink display, or an OLED display. The charge controller 112 is operable to drive the remote display 606 to display the state of charge of the battery, the battery voltage, charge current, the time elapsed since the beginning of a charging cycle, amp-hours returned, the charge algorithm currently being used, the temperature of the battery 152, and other data that may be relevant to the user.

The remote display 606 may be in a location that is easily visible to the user of the battery 152 and/or the charging system 100. The remote display 606 may be wirelessly connected to the charge controller 112 or connected via a display cable. The remote display 606 may comprise a user input device, for example, a touch screen. The remote display 606 enables a user to enter information relating to battery, the expected usage of the battery, or manually select the charging algorithm. The remote display 606 enables a service technician to perform more complex configuration of the charging system 100.

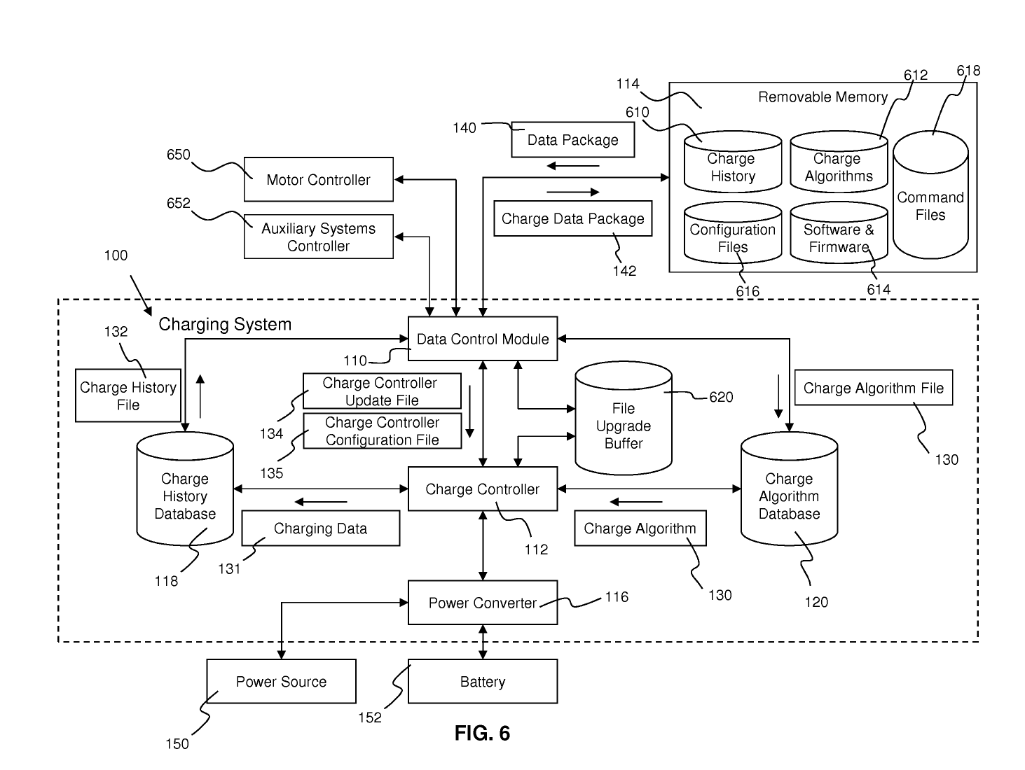

Turning now to FIG. 6, the charging system 100 may be installed on a product or device comprising a plurality of other systems. The device of FIG. 6 comprises a motor controller 650 and an auxiliary systems controller 652.

The data control module 110 may also be used to provide software and/or firmware update files, configuration files, control algorithm files, or other types of files to other systems in communication with the data control module 110. For example, if the charging system is installed on a golf cart, a motor controller 650 and an auxiliary systems controller 652 on the cart may be in communication with the data control module 110. As such, the data control module 110 may operate as a configuration interface through which various modules outside of the charging system 100 may exchange data with a removable memory 114. It will be appreciated that the data exchange with the removable memory 114 initiated and controlled by the data control module 110 may comprise software updates, firmware updates, configuration files, history files from various modules in communication with the data control module (e.g. motor control history files, braking system controller history files), instructions, or other types of data.

For example, it will be appreciated that the data control module 110 is operable to process the data package 140 to extract one or more of a motor controller update file, a motor controller configuration file, or a motor control algorithm file and provide one or more of these files to the motor controller 650. Similarly, the data control module 110 may obtain a motor control history file from the motor controller and store the motor control history file on the removable memory 114.

The removable memory 114 may comprise distinct databases stored thereon. For example, the removable memory 114 may comprise a charge history database 610 for storing charge history files provided by the data control module 110, a charge algorithms database 612 for storing charge algorithm files 130 that the data control module 110 can obtain and provide to the charge algorithm database 120 on the charging system 100, a software and firmware database 614 for storing charge controller update files 134, and a configuration file database 616. The removable memory 114 may further comprise a commands database 618 upon which command files comprising computer executable instructions may be obtained and executed by the data control module 110. The command files may comprise commands for testing components, requests for data, installation commands, algorithm selection commands, or commands relating to servicing the charging system. It will also be appreciated that the data control module 110 may obtain commands from the commands database 618 that relate to systems other than the charging system 100. For example, the commands may be delivered to, and executed by, the motor controller 650, or the auxiliary systems controller 652.

Referring again to FIG. 6, the charge controller 112 may be in communication with a file buffer 620. The file buffer 620 comprises a memory which is operable to store a firmware update, a software update, or configuration files for the charge controller 112. When the data control module 110 upgrades or reconfigures the charge controller 112, a copy of the previous configuration or installation file may be stored on the file buffer 620. The file buffer 620 may store more than one previous version of an update file. The data control module 110 or the charge controller 112 may store the one or more previous versions of an update in the file buffer 620.

In the event that the update or reconfiguration of the charge controller 112 is unsuccessful, the data control module 110 may initiate a process whereby a previous configuration file, software file, or firmware file stored on the file buffer 620 is installed on the charge controller 112. For example, if the data control module 110 attempts to update the firmware of the charge controller 112 from version 1 to version 2, the data control module 110 or the charge controller 112 stores a copy of firmware version 1 on the file buffer 620. If an error is encountered in the installation of version 2, the data control module 110 may obtain version 1 from the file buffer 620 and initiate a reinstallation of version 1 on the charge controller 112. Any success, progress, error, or other messages generated in the installation may be obtained by the data control module 110 and stored in the removable memory 114 to enable a user to review the error message and troubleshoot the installation process. The messages generated in the installation can further be used to confirm the success of the installation. The file buffer 620 reduces the probability that the charge controller 112 will be unsuccessfully updated and be left inoperable.

Turning back to FIG. 6, the data control module 110 may also be in connection with the file upgrade buffer 620. The data control module 110 may be operable to obtain software and/or firmware updates for the data control module 110 from the removable memory 114 and store these updates in the file upgrade buffer 620. The data control module 110 may then be upgraded by using the software or firmware update in the file upgrade buffer 620. For example, the data control module 110 may initiate the update or another module such as the charge controller 112 may initiate the update.

Although the above has been described with reference to certain specific example embodiments, various modifications thereof will be apparent to those skilled in the art.

1. A system for data transfer comprising:
a charging system having a data control module, the data control module being at least operable to:
detect a connection with a removable memory module;
identify and select a file on the removable memory;
obtain the selected file from the removable memory.

2. The system of claim 1 wherein the data control module is further operable to provide data to the removable memory module.

3. The system of claim 1 wherein the removable memory module is a USB drive.

4. The system of claim 1 wherein the charging system further comprises a charge algorithm database configured to store a charge algorithm, the charge algorithm database in communication with the data control module.

5. The system of claim 1 wherein the charging system further comprises a charge history database configured to store charge data, the charge history database in communication with the data control module.

6. The system if claim 1 wherein the charging system is further operable to charge two or more batteries simultaneously.

7. The system of claim 1 wherein the selected file comprises at least one of firmware, a configuration file, and a charging algorithm.

8. The system of claim 1 wherein the data control module is operable to identify and select the selected file by being further operable to search for an updated file on the removable memory module and, wherein the updated file is selected.

9. The system of claim 1 wherein the data control module is further operable to store charge history data on the removable memory, the charge history data comprising at least one of battery capacity, battery state of charge, a cumulative charge cycle count for a battery, a battery serial number, an error code, and a model number of a component in the system.

10. The system of claim 1 wherein, after detecting the connection with the removable memory module, the data control module is further operable to detect whether relevant data is present on the removable memory module and to output an error condition when the relevant data is not present.

11. A method of data transfer comprising:
a data control module in a charging system detecting a connection with a removable memory module;
the data control module identifying and selecting a file on the removable memory; and
the data control module obtaining the selected file from the removable memory.

12. The method of claim 11 further comprising the data control module providing data to the removable memory module.

13. The method of claim 11 wherein the removable memory module is a USB drive.

14. The method of claim 11 further comprising storing a charge algorithm on a charge algorithm database, the charge algorithm database in communication with the data control module.

15. The method of claim 11 further comprising storing charge data on a charge history database, the charge history database in communication with the data control module.

16. The method of claim 11 further comprising the charging system charging two or more batteries simultaneously.

17. The method of claim 11 wherein the selected file comprises at least one of firmware, a configuration file, and a charging algorithm.

18. The method of claim 11 further comprising the data control identifying and selecting the selected file by searching for an updated file on the removable memory module and, wherein the updated file is selected.

19. The method of claim 11 further comprising the data control module storing charge history data on the removable memory, the charge history data comprising at least one of battery capacity, battery state of charge, a cumulative charge cycle count for a battery, a battery serial number, an error code, and a model number of a component in the charging system.

20. The method of claim 11 further comprising, after detecting the connection with the removable memory module, the data control module detecting whether relevant data is present on the removable memory module and outputting an error condition when the relevant data is not present.
